(19) United States
(12) Patent Application Publication
(10) Pub. No.: US 2014/0028463 A1
(43) Pub. Date: Jan. 30, 2014

(54) METHODS AND SYSTEMS FOR DETECTION OF SENSOR TAMPERING

(71) Applicants: Subramanyam Satyasurya Chamarti, Johns Creek, GA (US); Mofeez Murtaza, Suwanee, GA (US); Steven Lee Bietz, Cumming, GA (US); William Frederick Ansell, III, Dover, NH (US)

(72) Inventors: Subramanyam Satyasurya Chamarti, Johns Creek, GA (US); Mofeez Murtaza, Suwanee, GA (US); Steven Lee Bietz, Cumming, GA (US); William Frederick Ansell, III, Dover, NH (US)

(73) Assignee: GENERAL ELECTRIC COMPANY, Schenectady, NY (US)

(21) Appl. No.: 13/559,513

(22) Filed: Jul. 26, 2012

(51) Int. Cl. G08C 15/06

(52) U.S. Cl. 340/870.02

(57) ABSTRACT

A system includes a utility meter, which includes a first sensor configured to detect usage of electric power, and a tamper detection system configured to detect an abnormality with an electrical current measurement from the first sensor as an indication of a tamper event associated with the first sensor.

### BACKGROUND

The invention relates generally to detection, and more particularly to methods and systems for the detection of sensor tampering.

Infrastructure, such as a smart grid, includes a variety of systems and components with sensors. In the smart grid example, systems may include power generation systems, power transmission systems, smart meters, digital communications systems, control systems, and their related components. Certain smart meters include a variety of sensors. Unfortunately, the smart meters and their sensors may be susceptible to unauthorized access and tampering.

### BRIEF DESCRIPTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In one embodiment, a system includes a utility meter, which includes a first sensor configured to detect usage of electric power, and a tamper detection system configured to detect an abnormality with an electrical current measurement from the first sensor as an indication of a tamper event associated with the first sensor.

In a second embodiment, a system includes a tangible machine readable medium including tamper detection instructions configured to measure a real power, measure a reactive power, determine if the real power, the reactive power, or a combination thereof, are measured at approximately zero for over a time period. If the real power, the reactive power, of the combination thereof, are measured at approximately zero for over the time period, then collect a plurality of sample data from a current, a voltage, or a combination thereof, received by a sensor. Validate the data. If the data is not valid, determine that a sensor has been tampered. If the data is valid, determine that the sensor has not been tampered. The sensor is included in a utility meter.

In a third embodiment, a method includes detecting an abnormality with a measured reading of a usage of a utility from a sensor as an indication of a tamper event associated with the sensor of a utility meter. The sensor is configured to provide an indication of an electrical current usage used by an end user.

### DRAWINGS

These and other features, aspects, and advantages of the present invention will become better understood when the following detailed description is read with reference to the accompanying drawings in which like characters represent like parts throughout the drawings, wherein:

FIG. 1 is a block diagram of an embodiment of an intelligent generation, transmission, and distribution infrastructure (e.g., a smart grid infrastructure) system;

FIG. 2 is a block diagram of an embodiment of an smart power meter system included in the system of FIG. 1;

FIG. 3 is a flowchart of an embodiment of a process suitable for sensing the removal of a current sensor included in the smart power meter system of FIG. 2; and

FIG. 4 is a flowchart of an embodiment of a process suitable for validating collected data for the smart power meter system of FIG. 2.

### DETAILED DESCRIPTION

One or more specific embodiments of the invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the invention, the articles “a,” “an,” “the,” and “said” are intended to mean that there are one or more of the elements. The terms “comprising,” “including,” and “having” are intended to be inclusive and mean that there may be additional elements other than the listed elements.

Certain infrastructure, such as an electric smart grid, may include a variety of interconnected systems and components. For example, the smart grid may include power generation systems, power transmission and distribution systems, metering systems, digital communications systems, control systems, and their related components. Smart meters incorporate many functionalities relating to the consumption of utilities, such as water, electricity, gas, and so forth. For example, smart meters may enable a utility provider, such as an electricity provider, to remotely monitor consumer use of the utility. In this way, the utility provider may rarely, if ever, physically access the smart meter. However, in certain circumstances, such as when the smart meter malfunctions, the utility provider, the consumer, or a technician may physically access the meter. For example, a technician employed by the utility provider may access the smart meter to perform maintenance on the meter. Therefore, the smart meter may include certain functionalities that are accessible to an authorized user to make adjustments to one or more operational parameters of the meter. Unfortunately, in certain situations, an unauthorized person may attempt to access these functionalities, for example in an attempt to restore the unauthorized delivery of electricity to an end user, such as a residence or a commercial building.

Accordingly, certain smart meters may be susceptible to tampering, such as by removing or disconnecting the sensors included within the smart meter. As used herein, the term “tampering” may refer to any method of interference that may render a device (e.g., meter) dysfunctional or functional beyond an intended and authorized functionality. Further, the techniques described herein may detect the removal, disconnection, or damage of certain sensors, such as current sensors, with minimal or no changes to hardware. Additionally or alternatively, the techniques described herein may detect magnetic flux variations and events of interest, e.g., events based on load profiling, time of use data, statistical analysis, and/or heuristic analysis, as described in more detail below. Indeed, the techniques described herein may be retrofitted to exiting smart meters without adding (or removing) hardware components.

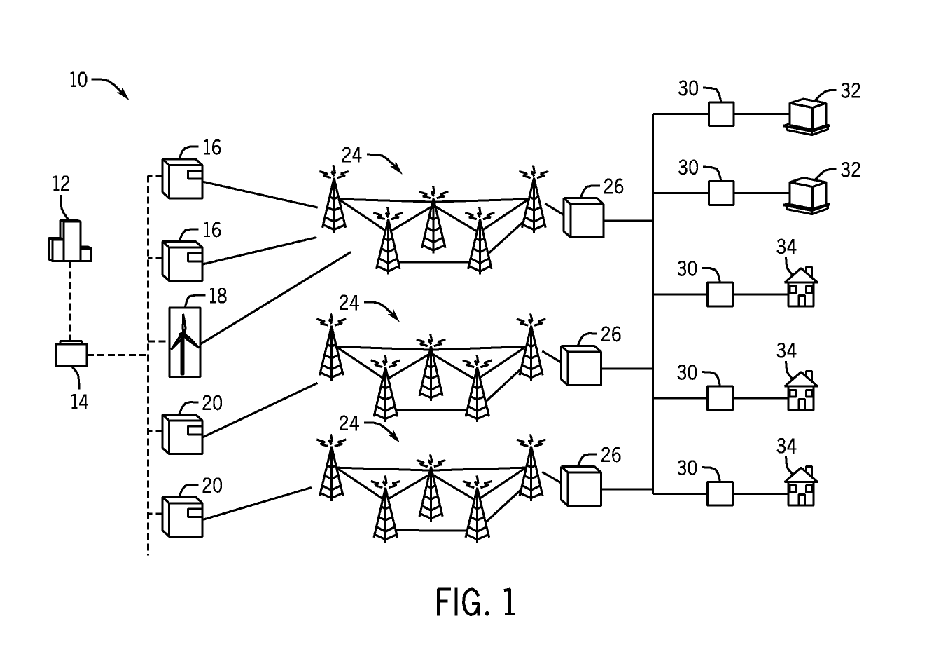

With the foregoing in mind, it may be useful to describe an embodiment of an infrastructure, such as an example smart grid system 10 illustrated in FIG. 1. It is to be noted that the systems and methods described herein may apply to a variety of infrastructure, including but not limited to power transmission and distribution infrastructure, gas delivery infrastructure, and water delivery infrastructure. As depicted, the smart grid system 10 may include one or more utilities 12. The utility 12 may provide for oversight operations of the smart grid system 10. For example, utility control centers 14 may monitor and direct power produced by one or more power generation stations 16 and alternative power generation stations 18. The power generation stations 16 may include conventional power generation stations, such as power generation stations using gas, coal, biomass, and other carbonaceous products for fuel. The alternative power generation stations 18 may include power generation stations using solar power, wind power, hydroelectric power, geothermal power, and other alternative sources of power (e.g., renewable energy) to produce electricity. Other infrastructure components may include a water power producing plant 20 and geothermal power producing plant 22. For example, water power producing plants 20 may provide for hydroelectric power generation, and geothermal power producing plants 22 may provide for geothermal power generation.

The power generated by the power generation stations 16, 18, 20, and 22 may be transmitted through a power transmission grid 24. The power transmission grid 24 may cover a broad geographic region or regions, such as one or more municipalities, states, or countries. The transmission grid 24 may also be a single phase alternating current (AC) system, but most generally may be a three-phase AC current system. As depicted, the power transmission grid 24 may include a series of towers to support a series of overhead electrical conductors in various configurations. For example, extreme high voltage (EHV) conductors may be arranged in a three conductor bundle, having a conductor for each of three phases. The power transmission grid 24 may support nominal system voltages in the ranges of 110 kilovolts (kV) to 765 kilovolts (kV). In the depicted embodiment, the power transmission grid 24 may be electrically coupled to power distribution substation 26. The power distribution substation 26 may include transformers to transform the voltage of the incoming power from a transmission voltage (e.g., 765 kV, 500 kV, 345 kV, or 138 kV) to primary (e.g., 13.8 kV or 4160V) and secondary (e.g., 480V, 240V, or 120V) distribution voltages. For example, industrial electric power consumers (e.g., production plants) may use a primary distribution voltage of 13.8 kV, while power delivered to commercial and residential consumers may be in the secondary distribution voltage range of 120V to 480V.

As again depicted in FIG. 1, the power transmission grid 24 and power distribution substation 26 may be part of the smart grid system 10. Accordingly, the power transmission grid 24 and power distribution substation 26 may include various digital and automated technologies to control power electronic equipment such as generators, switches, circuit breakers, reclosers, and so forth. The power transmission grid 24 and power distribution substation 26 may also include various communications, monitoring, and recording devices such as, for example, programmable logic controllers (PLC) and electric fault sensing protective relays. For example, during storms, a protective relay at power distribution substation 26 may detect an electrical fault downstream of the substation, and operate a circuit breaker to allow the fault to clear and restore electric power. In certain embodiments, the power transmission grid 24 and power distribution substation 26 may also communicate data such as changes in electric load demand to advanced metering infrastructure (AMI) 30.

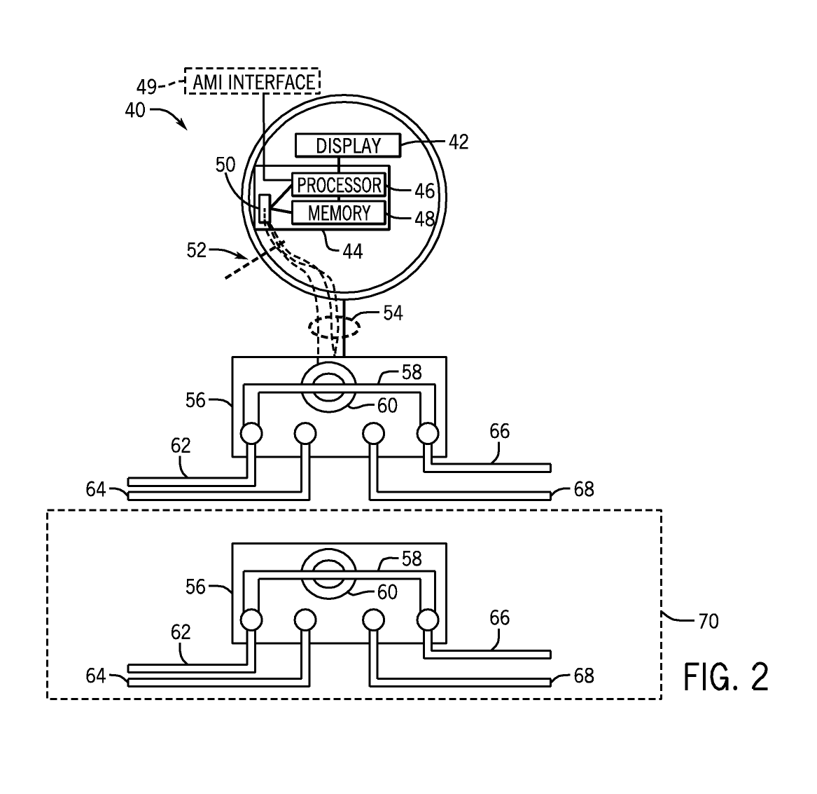

As previously discussed, an advanced metering infrastructure (AMI) 30 may be used to measure, collect, and analyze electricity, water, and/or gas usage. The AMI 30 may be communicatively coupled to one or more of the components of the smart grid 10, including the power transmission grids 24 and power distribution substation 26. Additionally, the AMI 30 may enable two-way communication between commercial sites 32, residences 34, and the utility control center 14, providing for a link between consumer behavior and utility consumption (e.g., electric, water, and/or gas consumption). For example, AMI 30 may track and account for pre-paid electricity, water and/or gas in a similar fashion to pre-paid cell phone usage. Likewise, the utility's consumers 32 and 34 may benefit from lower utility charges by optimizing their utility use, for example, to take advantage of lower rates during low demand hours. Washer/dryers, electric car chargers, and other flexible power consumption appliances may be programmed to operate during low demand hours, resulting in lower utility bills and a more balanced utilization of energy. In certain embodiments, the AMI 30 may include a system of electrical and electronic components such as, for example, a display, processors, memory devices, sensors, tampering detectors, bus bars, electrical conducting wires, and batteries. It should also be appreciated that the AMI 30 may measure, monitor, store, and display an apparent power (kVA), real power (i.e., the total power consumed by the resistive component of a given load over a time interval) (kW), and reactive power (i.e., the power consumed by the reactive component of a given load over a time interval) (kVar) as a product of power and time. For example, electric utilities may report to consumers their usage per kilowatt-hour (kWh) for billing purposes. The AMI 30 may include certain systems, as described in more detail with respect to FIG. 2, suitable for detecting tampering, magnetic flux variations, and/or events of interest. For example, the removal of certain current sensors may be more easily detected.

Turning now to FIG. 2, the figure is a block diagram of an embodiment of a tampering detection metering system 40. The metering system 40 may be included in the AMI 30, which may additionally include monitoring and communications functionalities, as previously discussed. The metering system 40 may be a single-phase or poly-phase system. As also depicted, the metering system 40 may include a display 42 communicatively coupled to an electronic board 44 to display electricity consumption and generation in recorded time intervals or real-time. For example, the display 42 may be a liquid crystal display (LCD) to display parameters such as real power in kilowatt-hours (kWh), reactive power in kilovar-hours (kVarh), current in amperes (A), voltage in volts (V), or some combination thereof. The display 42 may also display power (e.g., apparent, real, and reactive) delivered to the consumer 32, 34, from the utility 12, as well as power generated by the consumer 32, 34, to deliver to the grid. For example, the consumer 32, 34 may interconnect a distributed generation (DG) resource (e.g., solar panels or wind turbines) to generate and deliver power to the distribution substation and grid 26.

In certain embodiments, the electronic board 44 may further include a processor 46 and/or other data processing and sensing circuitry that may be operatively coupled to a memory 48 to execute instructions for carrying out the presently disclosed techniques. These instructions may be encoded in programs or code stored in tangible non-transitory computer-readable medium, such as the memory 48 and/or other storage. The processor 46 may be a general purpose processor, system-on-chip (SoC) device, or some other processor configuration. The electronic board 44 may, in addition, include metrology circuitry, analog front end (AFE) circuitry, voltage reference circuitry, real-time clocks, data converters, and similar electronic circuitry and architectures. In an embodiment, the processor 46 and the memory 48 of the electronic board 44 may process, record, and store data received from a current sensor 60 of a bus bar 58 and source-side and load-side live and neutral conductors 62, 64, 66, and 68. For example, the processor 46 and the memory 48 of the electronic board 44 may, in time intervals or in real-time, sample single or poly-phase current (A), voltage (V), apparent power (kVA), real power (kW), reactive power (kVar), and power factor data, and report that data to the consumer or the utility. The processor 46 and memory 48 of the electronic board 44 may also support various embedded software and firmware applications and systems. For example, in certain embodiments, the processor 46 and memory 48 may support metrology, emulator, and sensing scheme applications and systems. The metrology circuitry and applications supported by the electronic board 44 may include code or instructions stored in a non-transitory machine-readable medium (e.g., memory 48) and used to read and analyze analog or digital current or voltage inputs, and determine if metering system 40 has undergone a tampering. In certain embodiments, the processor 46 and memory 48 of the electronic board 44 may further support an AMI interface 49. For example, the AMI interface 49 may be used to communicate in real-time or near real-time with the utility, for example, for the purposes of reporting any type of metrology data or related information, such as power usage, power outages, events of interest (e.g., events based on load profiling, events based on time of use), and/or a tampering of the metering system 40. Additionally or alternatively, visual and/or audio indications, such as LEDs, visual displays, audio tones (e.g., beeps), voice recordings, and the like, may be used to communicate the aforementioned metrology data and related data, such as power usage, power outages, events of interest, and/or tampering of the metering system 40. Such visual and/or audio indications may be provided by the meter itself (e.g. by LEDs in the electronic board 44, LEDs visible from outside the meter, a visual panel inside the meter, a visual panel visible from outside the meter housing, a speaker), or by using other techniques such as wired communications, wireless communication, near field communications (NFC), and the like.

Furthermore, the electronic board 44 of the metering system 40 may also include a sensor input header 50 communicatively coupled to the processor 46 and the memory 48. In certain embodiments, the metering system 40 may also include one or more of the current sensor 60. The current sensor 60 may be electrically and/or communicatively coupled to the bus bar 58, and each of the current sensor 60 and the bus bar 58 may be housed inside a base 56. Depending on the sensor 60 type, the sensor 60 may be positioned contacting the bus bar 58, or adjacent to the bus bar 58, and communicatively coupled to the board 44. In some embodiments, the sensor 60 may be removable, such as when using split core current transformers and/or removable Rogowski coil(s), as the sensor 60. In other embodiments, the sensor 60 may be permanently affixed. The bus bar 58 may be a bar or strip of conducting material (e.g., copper, aluminum, or other metals and metal alloys) for connecting the distribution substation 26 to an end user via the metering system 40. In certain embodiments, the current sensor 60 may be any device that outputs a signal (e.g., AC/DC voltage or current) proportional to a detected electrical current flowing through the electrically and/or communicatively coupled bus bar 58. For example, the metering system 40 may be a 120VAC residential power meter. The current sensor 60 may continuously monitor the current flowing through the bus bar 58 to detect events such as power outages, electrical faults, decreases in current due to load changes, changes in magnetic flux, and so forth. The current sensor 60 may then output a signal proportional to the current detected flowing through the bus bar 58 to the electronic board 44, where a determination may be made to communicate the current data to the consumer 32, 34 or the utility 12. The current sensor 60 may include a primary and secondary winding, and may produce in the secondary winding a current or voltage that is proportional to a load or line current flowing through the primary winding. Accordingly, in one embodiment, the current sensor 60 may be a current transformer (CT). In such an embodiment, the primary winding of the current sensor 60 may be electrically and/or communicatively coupled to the source-side live and neutral conductors 62 and 64 and bus bar 58, and the secondary winding may be electrically and/or communicatively coupled to the electronic board 44 via electrical leads 54 and sensor input header 50. For example, the current sensor 60 may measure a load current in the range of a few amps (A) to a few kiloamps (kA) on the primary winding, and may produce on the secondary winding a current in the range of a few milliamps (mA) to few hundred milliamps (mA) for sensing and processing. In another embodiment, the current sensor 60 may include a burden resistor or other resistive component (e.g., shunt resistor), which may be used to measure an output voltage on the secondary side of current sensor 60, as well as to determine if a tampering (e.g., removal of the sensor 60) of the metering system 40 has taken place.

In other embodiments, the current sensor 60 may be a Rogowski coil or a resistive shunt. Accordingly, the current sensor 60 may include a helical or like shaped wire or coil, e.g., circular shape, as depicted in FIG. 2, which may produce and output an approximately proportional instantaneous (i.e., time-varying) voltage in response to an AC current passing through the source-side and load-side live and neutral conductors 62, 64, 66, and 68 and bus bar 58. It should also be appreciated that the Rogowski coil embodiment of the current sensor 60 may, in one embodiment, include a non-magnetic substrate and a dielectric material positioned between an air-gap between the coil of the sensor 60 and, for example, the bus bar 58. For example, the dielectric material may be employed to reduce undesirable capacitive coupling between the coil of the sensor 60 and the bus bar 58, and thus improve the accuracy of the current sensor 60 in detecting current flowing through the bus bar 58 and/or the source-side and load-side live and neutral conductors 62, 64, 66, and 68.

As noted above, the current sensor 60 may also include the electrical leads 54, which may couple electrically at a first end to current sensor 60, and couple electrically at an opposing end to sensor input header 50. The electrical leads 54 may include power electrical leads, a neutral or ground electrical lead, data transmit and receive electrical leads, or any combination thereof. In some embodiments, the electrical leads 54 may be color-coded corresponding to the function of the lead. For example, the colors red and black may respectively correspond to power and neutral leads, while the colors white, blue, or green, for example, may correspond to data-carrying leads. In the embodiment including a Rogowski coil current sensor 60, for example, the electrical leads 54 may encircle the coil from a first end of the coil to the opposing end of the coil. This arrangement may reduce current sensor 60 sensitivity to rogue magnetic fields when monitoring the bus bar 58. It may also further enable the current sensor 60 to output a signal (e.g., DC voltage) to the electronic board 44 that is proportional to the measured AC current of bus bar 58. As previously discussed, in one embodiment, the current sensor 60 may also be a shunt resistor. Accordingly, the current sensor 60 may, in addition, include a shunt resistor or a number of shunt resistive components that shunts or diverts the majority of the detected current flowing through bus bar 58 for sensing and processing.

As it may be worth noting, a CT embodiment of the current sensor 60 may technically and theoretically differ from a Rogowski coil embodiment of the current sensor 60. The same may be said for the resistive shunt embodiment of the current sensor 60. However, as will be discussed in further detail, the systems and methods disclosed herein may detect a tampering 52 of the current sensor 60, and by extension, a tampering of the metering system 40, irrespective of the current sensor 60 embodiment (e.g., CT, Rogowski coil, shunt resistor). Also depicted is a second phase system 70 for the system 40, thus providing for poly-phase operations of the system 40. The system 70 may include components 56, 58, 60, 62, 64, 66, and 68, as depicted above, with current being provided in a different phase. Additional phase systems may be provided, thus resulting in the system 40 including 3 or any number of phases. For each phase that includes the current sensor 60, the techniques described herein may operate in a similar manner. That is, each current sensor 60 may be used as described herein to detect tampering or removal of its respective phase when the system 40 is embodied in a poly-phase system 40.

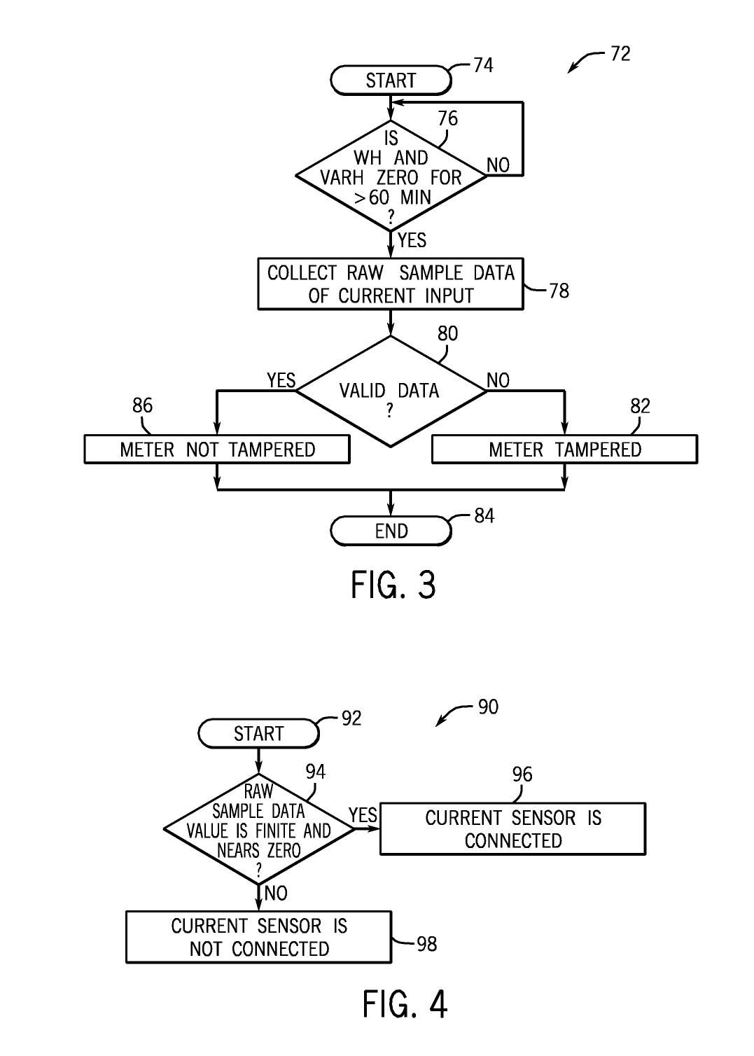

As previously discussed, the metering system 40 may include the sensor input header 50. In certain embodiments, the sensor input header 50 may couple electrically and/or communicatively at one end to the current sensor 60 via electrical leads 54, and couple electrically and/or communicatively at the opposing end to the electronic board 44. The input header 50 may include analog inputs, discrete inputs, digital inputs, or some combination thereof. In certain embodiments, the sensor input header 50 may be configured as part of a tampering detection mechanism of the metering system 40. For example, in some embodiments, the tampering 52 may occur by a disconnection or removal of current sensor 60 via input header 50 and electrical leads 54. Additionally, for example, a consumer or other unauthorized personnel may access metering system 40, and cut off the electrical leads 54 of the current sensor 60. Without the disclosed embodiments of tamper detection, the tampering 52 of the current sensor 60 may thus allow the consumer to continue consuming energy, presumably at no cost. In a similar example, the tampering 52 may occur by the consumer or other unauthorized personnel disconnecting or decoupling the sensor input header 50 of current sensor 60 from the electronic board 44. Again, without the disclosed embodiments of tamper detection, this would enable the consumer to consume energy undetected and unrecorded by the utility. As described in more detail below with respect to FIGS. 3 and 4, certain processes may detect the tampering and removal of, for example, the current sensor 60.

Turning now to FIG. 3, a flow diagram is presented, illustrating an embodiment of a process 72 useful in sensing and detecting the tampering 52 of the current sensor 60 included in the metering system 40 depicted in FIG. 2. The process 40 may include code or instructions stored in a non-transitory machine-readable medium (e.g., the memory 48) and executed, for example, by the processor 46. The metering system 40 may continuously or periodically perform the process 72 presented in FIG. 3 to constantly monitor whether or not a tampering 52 of current sensor 60, and by extension, the metering system 40, has taken place. For example, the metering system 40 may periodically perform the process 72 during normal operating conditions (e.g., power service consumed as authorized), but may continuously or periodically also perform the process 72 during times of restricted power usage due to the utility 12 or the consumer 32, 34.

The process 72 may begin (block 74) with the electronic board 44 of the metering system 40 determining (decision 76) if the current sensor 60 has measured approximately zero real power in watt-hours (Wh) or in kilowatt-hours (kWh) and reactive power in var-hours (Varh) or in kilovar-hours (kVarh) over, for example, an approximately 1, 2, 5, 10, 15, 30, 45, 60, 120, 240 minute duration of time (decision 76). In other embodiments, decision 76 may be based on using load profiles, time of use data, and/or deriving events of interest. For example, statistical analysis and/or heuristic analysis (e.g., neural networks, expert systems, genetic algorithms) may be used to detect events of interest, such as high electric use at late hours of the night, fluctuations from “normal” use, such as fluctuations based on load profile data and/or time of use data, to derive information that may then be transmitted in addition to or alternative to tampering data. As previously discussed, the electric utility may program the metering system 40 to record and store the power consumed at a residential, commercial, industrial, or other facility over a 60-minute duration of time for appropriate billing purposes. Nevertheless, it should be noted that the metering system 40 may be capable of measuring a real power and a reactive power over any time interval. The electronic board 44 may perform a series of calculations to determine the amount of measured power. For example, the processor 46 and the memory 48 of the electronic board 44 may process and store the nominal voltage (e.g., 240VAC) of bus bar 58, and may multiply the nominal voltage by the sampled value of the detected AC current of the bus bar 58 to determine a value for power. Accordingly, if the electronic board 44 of metering system 40 determines that the real power, the reactive power, or any combination thereof, has been measured to be approximately greater than zero during a measurement time interval (e.g., approximately 1, 2, 5, 10, 15, 30, 45, 60, 120, 240 minutes), the metering system 40 repeats the process 72. However, in the case that approximately zero power (i.e., real power and/or reactive power) is measured over the measurement time interval, the electronic board 44 may then sample and process the real-time continuous current input of the bus bar 58 (block 78).

As previously discussed, the current sensor 60 may continuously detect an AC current flowing through the source-side live and neutral conductors 62 and 64, the load-side live and neutral conductors 66 and 68, and the current bus bar 58. A voltage output proportional to the detected AC current may be delivered to the electronic board 44 via the electrical leads 54 and sensor input header 50. Upon determining (decision 76) that zero power (i.e., real power and/or reactive power) has been measured for a duration of time (e.g., 60-minute or greater duration of time), the electronic board 44 may then collect via sensor input header 50 a bundle of raw sample data of the analog current input detected by current sensor 60 (block 78). In certain embodiments, the analog current input may be sampled in varying data amounts and over varying time durations. For example, in the current sensor 60 embodiment including the current transformer (CT), the electronic board 44 may collect data samples at a predetermined rate (e.g., 20 samples/second), whereas the shunt resistor current sensor 60 embodiment may obtain more data samples over a longer duration (e.g. 15-20 seconds) since the data processing includes integration of the analog current inputs.

In the depicted embodiment, the raw data samples of the collected analog current inputs may then be validated by the electronic board 44 (decision 80). The validation of the sampled analog current input data may determine (decision 80) whether or not the current sensor 60 is connected via electrical leads 54 and/or sensor input header 50 to the electronic board 44, and by extension, determine whether or not metering system 40 has undergone the tampering 52. The electrical leads 54 may deliver to the electronic board 44 the raw analog current input data, which may be referenced to a pre-configured reference voltage (e.g., 3.3-5VDC) of the electronic board 44 for measurement. In data conversion (e.g., analog-to-digital conversion [ADC]), the voltage reference may act as precise and accurate measurement benchmark, against which analog inputs may be compared. For example, for a residential metering system 40, which may, for example, include a single-phase, three-wire connection of current sensors 60, two voltages (e.g., V_{A} and V_{Ref}) and two currents (e.g., I_{A} and I_{B}). The two voltages and the two currents may be present or otherwise measured by the electronic board 44. For example, the voltage V_{A} may be the system nominal voltage input, and the currents I_{A} and I_{B} may be the incoming raw data of analog current inputs detected by each of the current sensors 60. The current inputs I_{A} and I_{B} may then each be referenced to a voltage reference V_{Ref} (e.g., 3.3VDC), duration of time such that the electronic board 44 resolves each of the current inputs I_{A} and I_{B} in a voltage measurement range of −3.3VDC to +3.3VDC. Thus, the incoming raw data of analog current inputs I_{A} and I_{B} may be both accurate and repeatable.

In certain circumstances, the metering system 40 may be susceptible to tampering by removing the current sensor 60 from electronic board 44. In such cases where the removal of current sensor 60 takes place, the sampled analog current inputs at the electronic board 44 may become random in nature, for example, due to the absence of a voltage reference. If the electronic board 44 of the metering system 40 determines that the raw samples of analog current inputs are random (e.g., invalid data at decision 80), then the metering system 40 may store, display, and/or communicate in real-time or near real-time to the utility via the AMI interface 49 that the tampering 52 has occurred (block 82), and the process 72 may then stop (block 84). If the process 72 determines (decision 80) that the data is valid, then the metering system 40 is likely not subject to tampering (block 86), and the process 72 may then end (block 84). The process 72 may then restart (block 74) after a desired time interval. The identification of random data for validation of the raw samples of analog current inputs is described in more detail in FIG. 4 below.

FIG. 4 is a flow chart of an embodiment of a process 90 suitable for validating the raw data samples through the use of random derivations. The process 90 may include code or instructions stored in a non-transitory machine-readable medium (e.g., the memory 48) and executed, for example, by the processor 46. The process 90 may first start (block 92) by determining if the raw sample data is finite (e.g., non-random) and approximately near zero (decision 94). In certain embodiments, a single-ended methodology may be used, in other embodiments, a differential input methodology may be used. That is, the process 90 begins by determining whether or not raw data of analog current inputs have finite values approximately close to zero, which may be expected as the electronic board 44 may be referenced to a predetermined reference voltage (e.g., analog 3.3V, digital signal, or any other voltage). If the raw sampled data is finite and nears zero (decision 94), then the current sensor 60 is likely properly communicatively coupled (block 96), and by extension the metering system 40 may have not undergone the tampering 52. As mentioned previously, the meter may be communicatively coupled by wired techniques (e.g., cabling), wireless techniques (e.g., wireless local area networks, wireless wide area networks), and/or near field communication techniques. By way of contrast, if the raw sampled data is not finite and does not near zero (decision 94), then the current sensor 60 is likely removed and/or not communicatively coupled (block 98), and by extension the metering system 40 may have undergone the tampering 52. In other words, the absence or communicative disconnection of the current sensor 60 from the electronic board 44 may be indicated by the raw data of analog current inputs becoming random, or irregular, due to the disconnection of the current sensor 60 from the predetermined reference voltage (e.g., 3.3VDC) of the electronic board 44. For example, if the voltage reference of the electronic board 44 is approximately 3.3VDC (e.g., measurement range of approximately −3.3VDC to +3.3VDC), then valid raw samples of analog current inputs may approach zero from both the negative direction and the positive direction due to, for example, the signal continuity to the 3.3VDC voltage reference. In the case that the raw samples of analog current inputs are measured substantially lesser or greater than zero, the metering system 40 may determine that current sensor 60 has been removed, and that metering system 40 has undergone the tampering 52.

As mentioned above, the aforementioned processes 72 and 90 may be implemented in a poly-phase metering system 40 having multiple sensors 60. For example, in a poly-phase, three-wire connection of current sensors 60, as previously discussed, the two current sensors 60 may both or each be disconnected or removed from the electronic board 44 of the metering system 40. Accordingly, each of the current inputs I_{A} and I_{B} may each, or the combination of the two, be approximately less or greater than zero. In either the case, the metering system 40 may store, communicate, and display that the tampering 52 has taken place.

Technical effects of embodiments include the detection of smart meters that may have been tampered with, such as by removing the current sensors included within the smart meters By detecting, recording, and validating the input current of the metering system, the systems and methods described herein, may determine whether or not a tampering of the metering system via the removal of one or more current sensors has taken place, and report that tampering determination to the electric utility or other authorized body.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A system comprising:
a utility meter, comprising
a first sensor configured to detect usage of electric power; and
a tamper detection system configured to detect an abnormality with an electrical current measurement from the first sensor as an indication of a tamper event associated with the first sensor.

2. The system of claim 1, wherein the tamper event comprises a disconnection, a removal, or a combination thereof, of the first sensor.

3. The system of claim 1, wherein the first sensor comprises a current transformer, a Rogowski coil, a shunt, or a combination thereof.

4. The system of claim 3, wherein the Rogowski coil comprises a non-magnetic substrate, a coil, a dielectric material, or a combination thereof.

5. The system of claim 1, wherein the first sensor is configured to provide an indication of an electric current usage used by an end user.

6. The system of claim 1, wherein the tamper detection system comprises an electronic board comprising a tangible, machine readable medium configured to store instructions configured to detect the tamper event.

7. The system of claim 6, wherein the electronic board is configured to be flash upgraded with the instructions.

8. The system of claim 1, wherein the tamper detection system is configured to monitor the usage of the electric power versus time, and identify a random variation in the voltage measurement as an indication of the abnormality.

9. The system of claim 8, wherein the tamper detection system is configured to compare the voltage measurement against a reference value to detect the tamper event.

10. The system of claim 1, wherein the utility meter comprises an advanced meter infrastructure (AMI) smart meter.

11. The system of claim 1, comprising second sensor configured to detect usage of the electric power, wherein the first sensor is configured to detect a first current in a first phase, and the second sensor is configured to detect a second current in a second phase different from the first phase, and wherein the a tamper detection system configured to use the second sensor to detect a second tamper event associated with the second sensor.

12. A system comprising:
a tangible machine readable medium comprising tamper detection instructions configured to:
measure a real power;
measure a reactive power;
determine if the real power, the reactive power, or a combination thereof, are measured at approximately zero for over a time period;
if the real power, the reactive power, of the combination thereof, are measured at approximately zero for over the time period then
collect a plurality of sample data from a current, a voltage, or a combination thereof, received by a sensor;
validate the data;
if the data is not valid, determine that a sensor has been tampered; and
if the data is valid, determine that the sensor has not been tampered, wherein the sensor is included in a utility meter.

13. The system of claim 12, wherein the utility meter comprises a smart power meter configured to store the tamper detection instructions in a memory.

14. The system of claim 13, wherein the memory is configured to be flash upgraded with the tamper detection instructions.

15. The system of claim 12, wherein the tamper detection instructions configured to validate the data comprise tamper detection instructions configured to compare the plurality of sample data to a reference voltage.

16. The system of claim 12, wherein the code configured to validate the data comprises code configured to determine if the plurality of sample data is approximately random, and if the data is approximately random, then determine that the current sensor has been disconnnected.

17. The system of claim 12, wherein the tamper detection instructions configured to validate the data comprise tamper detection instructions configured to determine if the plurality of sample data is approximately finite in value, and if the data is approximately finite in value, then determine that the current sensor has not been disconnected.

18. A method comprising:
detecting an abnormality with a measured reading of a usage of a utility from a sensor as an indication of a tamper event associated with the sensor of a utility meter, wherein the sensor is configured to provide an indication of an electrical current usage used by an end user.

19. The method of claim 18, wherein the detecting comprises monitoring the usage of the utility versus time, and identifying a random variation in the measured reading as an indication of the tamper event.

20. The method of claim 18, wherein detecting comprises identifying a potential occurrence of the tamper event via an identification of a total usage of the utility over a period of time being less than a minimum threshold, and then evaluating the potential occurrence of the tamper event by further evaluating the usage of the utility versus time in order to identify any unexpected temporal variation and/or value in the measured reading.

21. The method of claim 18, wherein detecting comprises comparing the measured reading to a reference value to detect the tamper event.

22. The method of claim 18, wherein the utility comprises an electric utility configured to transmit an electric power to the utility meter.
